(19) United States
(12) Patent Application Publication
(10) Pub. No.: US 2018/0247326 A1
(43) Pub. Date: Aug. 30, 2018

(54) WEARABLE RECYCLING AND CLEANING MONITOR

(71) Applicant: Panasonic Intellectual Property Management Co., Ltd., Osaka (JP)

(72) Inventors: Seth Melvin CRONIN, Essex Junction, VT (US); Justin KUNZ, Williston, VT (US)

(21) Appl. No.: 15/906,630

(22) Filed: Feb. 27, 2018

Related U.S. Application Data
(60) Provisional application No. 62/464,688, filed on Feb. 28, 2017.

(51) Int. Cl. G06Q 30/02; G06Q 10/00; G06K 7/10; G06K 19/07; G06K 19/077; G06F 1/16

(52) U.S. Cl. CPC G06Q 30/0208; G06Q 10/30; G06Q 30/0237; G06F 1/163; G06K 19/0723; G06K 19/07762; G06K 7/10425

(57) ABSTRACT

A system for waste disposal monitoring using wearable recycling and cleaning monitors includes a plurality of user devices each associated with a unique identifier and each configured to be carried by a respective user. A smart waste receptacle includes a receptacle configured to hold a plurality of waste items, a reader configured to detect the unique identifier of one user device when the user carrying the user device deposits a waste item in the receptacle portion, and a communication interface configured to transmit a notification including the detected unique identifier of the one user device based on the user depositing the waste item in the receptacle. A processing system and incentive redemption location device can be used to issue incentive to users based on a quantity of waste deposited by each user.

### CROSS-REFERENCE TO RELATED APPLICATION

This application claims priority from U.S. Provisional Application No. 62/464,688, filed on Feb. 28, 2017, the disclosure of which is incorporated by reference herein in its entirety.

### TECHNICAL FIELD

The present disclosure generally relates to wearable monitors. In particular, the disclosure relates to wearable recycling and cleaning monitors.

### DESCRIPTION OF THE RELATED ART

Many theme parks, resorts, and similar types of service providers deal with large amounts of garbage, including recycled waste. Venues generally provide trash receptacles distributed throughout the area, as well as human operators to clean up the trash that guests may discard in places other than designated receptacles.

Despite the presence of receptacles, however, some guests may choose not to utilize the same for a variety of reasons. Although some programs exist for incentivizing clean-up, such programs generally rely on rewarding guests for picking up bags of garbage (e.g., offering a prize for turning in a garbage bag full of recyclable bottles). There are currently no available programs to incentivize individuals to merely throw away their own garbage.

There is, therefore, a need in the art for improved systems and methods for wearable recycling and cleaning monitors.

### SUMMARY

Systems and methods are provided for monitoring of waste disposal using wearable recycling and cleaning monitors.

An illustrative system for waste disposal monitoring using wearable recycling and cleaning monitors may include a plurality of user devices each associated with a unique identifier and each configured to be carried by a respective user. A smart waste receptacle may include a receptacle configured to hold a plurality of waste items, a reader configured to detect the unique identifier of one user device of the plurality of user devices when the user carrying the one user device deposits a waste item in the receptacle portion, and a communication interface configured to transmit a notification including the detected unique identifier of the one user device based on the user carrying the one user device depositing the waste item in the receptacle.

An illustrative method for waste disposal monitoring using wearable recycling and cleaning monitors can include detecting, by a reader of a smart waste receptacle configured to hold a plurality of waste items, a unique identifier of a user device configured to be carried by a respective user. An input monitor of the smart waste receptacle detects that the user carrying the user device has deposited a waste item in the smart waste receptacle. In turn, a notification is transmitted from the smart waste receptacle, the notification including the detected unique identifier of the user device when the input monitor detects that the user has deposited the waste item in the smart waste receptacle.

### BRIEF DESCRIPTION OF THE DRAWINGS

FIG. 1 illustrates an exemplary network environment in which a system for wearable recycling and cleaning monitoring may be implemented.

FIG. 2 is a flowchart illustrating an exemplary method for wearable recycling and cleaning monitoring.

FIG. 3 is a flowchart illustrating an exemplary incentives method that may be used in a system for wearable recycling and cleaning monitoring.

FIG. 4 is a flowchart illustrating an exemplary incentive selection method that may be used in a system for wearable recycling and cleaning monitoring.

FIG. 5 is a flowchart illustrating an exemplary incentive calculation method that may be used in a system for wearable recycling and cleaning monitoring.

FIG. 6 illustrates an exemplary set of entries from an available incentives database that may be used in a system for wearable recycling and cleaning monitoring.

FIG. 7 illustrates an exemplary set of entries from an active incentives database that may be used in a system for wearable recycling and cleaning monitoring.

FIGS. 8A-8C illustrate exemplary graphic user interfaces (GUIs) that may be used in a system for wearable recycling and cleaning monitoring.

FIG. 9 illustrates an exemplary computing system (e.g., user device, resort network server, smart connected waste receptacle, incentive redemption location device) that may be used to implement an illustrative embodiment.

### DETAILED DESCRIPTION

Examples of wearable recycling and cleaning monitors are described herein. An exemplary system for wearable recycling and cleaning monitoring may include a wearable device associated with a unique identifier and one or more smart waste/recycling receptacle(s). Such a smart receptacle may include a receptacle portion configured to receive and hold a plurality of garbage or recycling items, a reader or sensor that detects the unique identifier of the wearable device when a user/guest/wearer of the wearable device deposits a garbage item in the receptacle portion, and a communication interface that transmits a notification identifying the detected unique identifier for use in tracking the user's/guest's/wearer's progress toward a predetermined reward based on the garbage item having been deposited by the user/guest/wearer as identified by the unique identifier.

As guests navigate through a venue (e.g., theme park or resort), the guests may dispose of trash (including recyclable trash) using a network of smart waste receptacles that are communicatively connected to a network and server. The guests may reveal their identity at the time of trash disposal using assigned wearable monitoring devices each associated with a unique identifier. Each receptacle may read guest information from the guest's wearable monitoring device, which may take the form of a computing device (e.g., wearable device, smartphone) and/or an access card or other experience access device (e.g., theme park cards). As the receptacles receive guest information in conjunction with the deposited trash or recyclables, the receptacles may communicate the received guest information to a resort network server. Based on the received guest information, an incentive management application in the resort network server may be triggered and execute a series of incentive rules to track progress of the guest towards a reward incentive and/or reward the guest with issuance of a new incentive. The incentive management application of the resort network server may coordinate in the issuance of the incentives with a guest experience management application to enhance various guest experiences for the guests based on earned incentives. In some embodiments, guests may thus be provided with access to a short-cut or shorter wait time at a thrill ride when a predetermined incentive threshold is met.

Waste management operations may save operational costs associated with venue clean-up personnel, since visitors are incentivized to put waste in receptacles. The guest experience may also be improved by providing a cleaner resort environment. Operators may also receive valuable data on visitor habits and park cleanliness. The data could be used for planning positive design changes to parks/resorts.

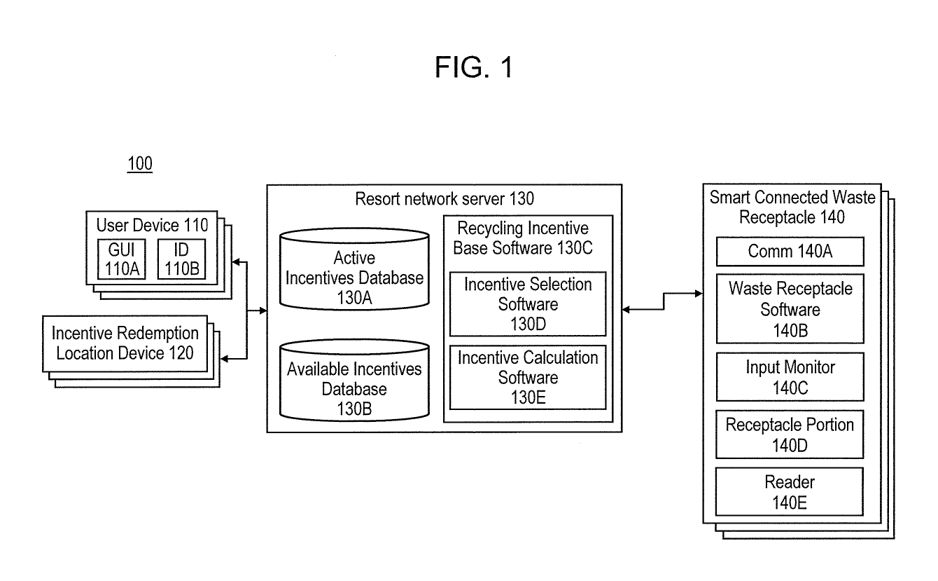

FIG. 1 illustrates an exemplary network environment 100 in which a system for wearable recycling and cleaning monitoring may be implemented. Network environment 100 includes one or more user device(s) 110, one or more incentive redemption location device(s) 120, a resort network server 130, and one or more smart connected waste receptacle(s) 140. Such a system may be used for monitoring waste/recycling deposited by users in a venue through the use of wearable user devices 110 and the smart connected waste receptacles 140, offering incentives to users to encourage proper waste/recycling disposal through the tracking of each user's progress towards meeting an incentive goal. The resort network server 130 is in wired or wireless communication with the plurality of user devices 110, the plurality of incentive redemption locations 120, and the plurality of smart connected waste receptacles 140.

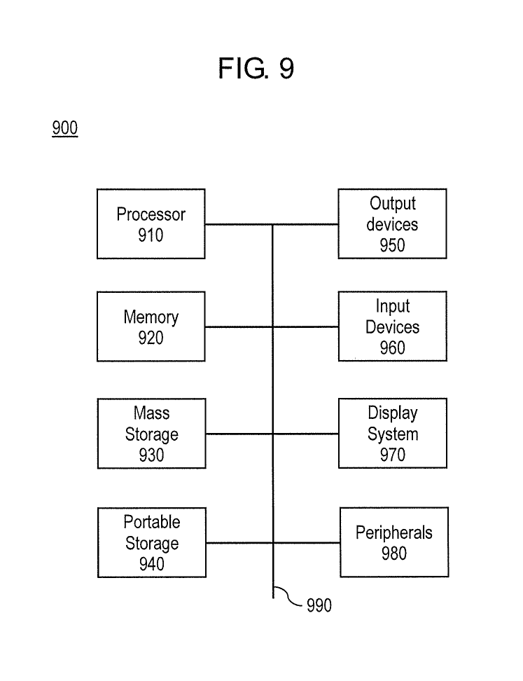

User device 110 may be any type of communication device known in the art, including a general purpose computer, mobile phone, smartphone, personal digital assistant (PDA), portable computing device (e.g., laptop, netbook, tablet), desktop computing device, handheld computing device, or any other type of computing device capable of communicating over a communication network. User device 110 may be inclusive, for example, of a computing device such as that described with respect to FIG. 9 herein. In some embodiments, user device may also be inclusive of a wearable device, including a smartwatch, wristband, and other wearable item capable of communicating at least a unique identifier.

User device 110 may include graphical user interface (GUI) 110A and an assigned unique identifier (ID) 110B. User device GUI 110A may include any graphic user interface that can request and receive user input regarding preferences, registration, and other user-related information that may be used in monitoring recycling and cleaning activities, as well as display information regarding the same. Unique identifier 110B may be any type of identifier that is uniquely associated with the user device 110. Such unique identifier 110B may therefore be used to identify a particular user device 110 from among a plurality of user devices; the particular user device 100 and associated unique identifier 110B may in turn be uniquely associated or assigned to a particular guest.

The user device 110 may be, for example, a simple wearable device that is specific to the task for providing the unique identifier 110B to external readers or receivers, or the user device 110 may be a complex computing device (e.g., a smartphone with an NFC reader and downloaded or otherwise installed application) capable of communicating the unique identifier 110B and engaging in other processing functions. Whether via NFC, Bluetooth, RFID, or other types of wireless communication capabilities, the user device 110 is capable of communicating its unique identifier 110B to a reader or other receiver associated with one or more smart connected waste receptacle(s) 140.

Redemption location devices 120 may be located throughout the venue (e.g., at thrill rides in a theme park) and may each have a connection to the resort network server 130. Such redemption location devices 120 may pull information regarding progress made by users/guests toward certain rewards so that when a guest wishes to redeem a particular reward, the redemption location devices 120 can confirm the achievement and authorize or issue the reward.

Resort network server 130 may include any type of server or other networked computing device, including hardware computing components such as network and media interfaces, non-transitory computer-readable storage (memory), and a processing system including one or more processor(s) for executing instructions or accessing information that may be stored in memory. The functionalities of multiple servers may be integrated into a single server. Any of the aforementioned servers (or an integrated server) may take on certain clientside, cache, or proxy server characteristics. These characteristics may depend on the particular network placement of the server or certain configurations of the server.

Resort network server 130 may include an active incentives database 130A, an available incentives database 130B, and base software 130C that includes incentive selection software 130D and incentive calculation software 130E for execution by the processing system of the resort network server 130. Resort network server 130 may send and receive information over a communication network to/from the user device(s) 110, as well as the incentive redemption device(s) 120, and the smart connected waste receptacle(s) 140. Such information—which may include information associated with the unique identifier associated with one or more users/guests—may collectively be used to identify when a particular guest has qualified for certain rewards under certain promotions (e.g., a guest visiting a specified set of attractions and participating in a specified set of activities, such as disposing of trash in waste receptacles 140, may win points redeemable toward a prize). The promotions may be specific to the service provider or associated with third party advertisers.

Active incentives database 130A may store information in memory regarding a plurality of incentives that are currently active for the guests of the venue. For example, the active incentives database may maintain a record for each guest of the venue that is actively seeking to achieve an incentive, and each record may maintain the guest's progress towards achieving the incentive. Similarly, available incentives database 130B may store information in memory regarding a plurality of incentives that are currently available to the guests of the venue.

Resort incentive base software 130C includes instructions embodied in nontransitory computer-readable storage media. Such instructions may include parameters regarding various incentives programs. Each incentives program—which may be specific to a particular service provider or one of their venues—may specify a set of conditions to be met before a reward is provided. Multiple rewards may be available, each associated with a different set of conditions. Rewards or incentives may be offered based on any combination of number of attractions visited, variety of attractions visited, time spent waiting in line, types of purchases made within the venue, quantity and/or type of waste disposed is waste receptacles 140, and other factors reported to the resort network server 130. In particular, incentive selection software 130D may be executed to select an incentive for a guest, and incentive calculation software 130E may be executed to calculate progress towards a particular incentive.

The smart connected waste receptacles 140 may have a communication interface 140A capable of at least short range communication with user devices 110 and with the resort network server 130, waste receptacle software 140B, and an input monitor 140C, such as a scale, switch, or an optical or other type of sensor. Each smart connected waste receptacle 140 may also have a receptacle portion 140D and a reader 140E. The receptacle portion 140D is configured to hold a plurality of garbage items. The reader 140E detects unique identifiers of user devices 110. The reader 140E may be an NFC reader, for example. The smart connected waste receptacles 140 may further have a power source, a controller, memory, and processing system including one or more processor(s) (not shown).

The communication interface 140A and/or reader 140E of the smart waste receptacle 140 may be continually polling its immediate surroundings for the presence of a user device 110 within its detection range. When the smart waste receptacle 140 detects a user device 110 within a given detection perimeter or range (e.g., 1 foot, 3 feet, or the like) of the smart waste receptacle 140, the input monitor 140C may be activated to monitor and determine whether the user deposits waste/recycling in the smart connected waste receptacle 140 and, optionally, how much waste/recycling is deposited (e.g., by weight, volume, or the like). If the input monitor 140C indicates that user did not deposit anything, the smart waste receptacle 140 may return to polling for user devices 110 in its detection range. If the input monitor 140C does indicate that the user did deposit waste/recycling in the smart connected waste receptacle 140, the communication interface 140A may then send the unique identifier 110B of the detected user device 110 and the deposited quantity of waste/recycling to the resort network server 130, which may then execute recycling incentive base software 130C based on the same.

The recycling incentive base software 130C may search the active incentives database 130A for a record matching the unique identifier 110B of the user device 110. If a record exists, the actual/total deposit quantity is updated by adding the deposited quantity measured by the input monitor 140C of the smart connected waste receptacle 140 to the previous amount listed in the active incentives database 130A. If there is no record in the active incentives database 130A for the user device ID 110B, a new record may be created, and the deposited quantity is used to populate the amount in the active incentives database 130A.

The incentive selection software 130D may also be executed to retrieve data from the available incentives database 130B and to communicate the retrieved data to the user device 110 to as to populate the user device GUI 110A with certain options (e.g., via drop-down menus). One set of options may include information from the available incentives database 130B. Another set of options may be populated based on user selection of an attraction where the options may be specific to the selected attraction. Once the user makes a selection, the selected incentive may be saved to the user's record in the active incentives database 130A so as to track the user's progress towards achieving the selected option.

The incentive calculation software 130E may be executed to compare the actual deposited amount (e.g., as recorded for a user in the active incentives database 130A) to the incentive threshold (e.g., as established in the available incentives database 130B for the option selected by the user). If the actual deposited amount does not exceed the incentive threshold, the user device GUI 110A may simply display a percentage of the incentive threshold that is met currently by the actual deposited amount. If the actual deposited amount exceeds the incentive threshold, the user may be notified via the user device GUI 110A, and the user device ID 110B may be sent to the incentive redemption location(s) 120 (e.g., closest to the user or otherwise associated with the user). The incentive thresholds can be adjusted depending on the number (#) of visitors to the theme park. For example, when the park is very busy, because people are cramped/tired and more likely to avoid protocols, the incentive thresholds may be lowered. This will provide more incentives or rewards at the same compliance level. In some embodiments, incentives may be actively advertised to guests to encourage more purchases (e.g., where the incentive is a discount on purchased goods or redeemable at a facility where goods may be purchased) and/or to encourage guests to dispose of more trash/recycling in waste receptacles.

In some embodiments, the smart connected waste receptacle(s) 140 may identify a type of trash deposited (e.g., based on a bar code as read by a barcode reader). The incentive may further be based on the identified type of trash to encourage recycling or purchase of items associated with the venue (e.g., venue-branded soda bottles) versus non-readable personal or generic items.

The user device GUI 110A may further display informational content related to the incentives, such as directions to the next attraction or redemption location device 120. The user device GUI 110A may also be capable of displaying notifications from a smart waste receptacle 140 indicating unavailability (e.g., when completely full) and directing the user to another smart waste receptacle 140 that is nearby. Such a notification may further include additional incentives when such a user deposits trash in the other smart waste receptacle 140.

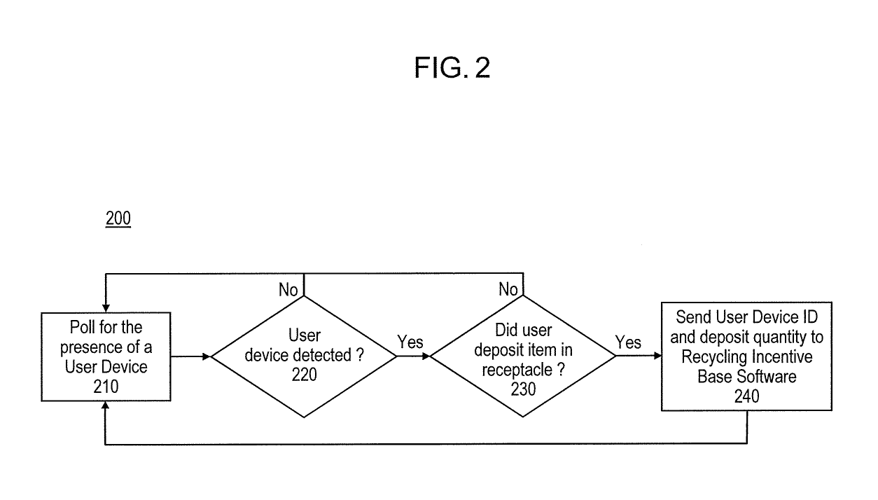

FIG. 2 is a flowchart illustrating an exemplary method 200 for providing services based on wearable recycling and cleaning monitors.

In step 210, the communication interface 140A or reader 140E of each smart waste receptacle 140 may be periodically or continually polling or monitoring its immediate surroundings for the presence of one or more user device(s) 110. In step 220, a processing system (e.g., including one or more processor(s)) of each smart waste receptacle 140 may determine whether a user device 110 is detected. If not, the method reverts to step 210 for more polling. When the communication interface 140A or reader 140E of the smart waste receptacle 140 detects a user device 110 inside of a given detection perimeter (e.g., 1 foot, 3 feet, or the like), the method proceeds to step 230 where the input monitor 140C determines if the user has deposited waste/recycling in the smart connected waste receptacle 140. If the input monitor 140C indicates that the user did not deposit anything, the method returns to step 210 for more polling or monitoring for user devices 110. If the input monitor 140C indicates that the user did deposit waste/recycling in the smart connected waste receptacle 140, the method proceeds to step 240 in which the communication interface 140A of the smart waste receptacle 140 sends the unique user device ID 110B of the detected user device 110 and a measure of the deposited quantity of waste/recycling to the resort network server 130 (e.g., to the recycling incentive base software 130C).

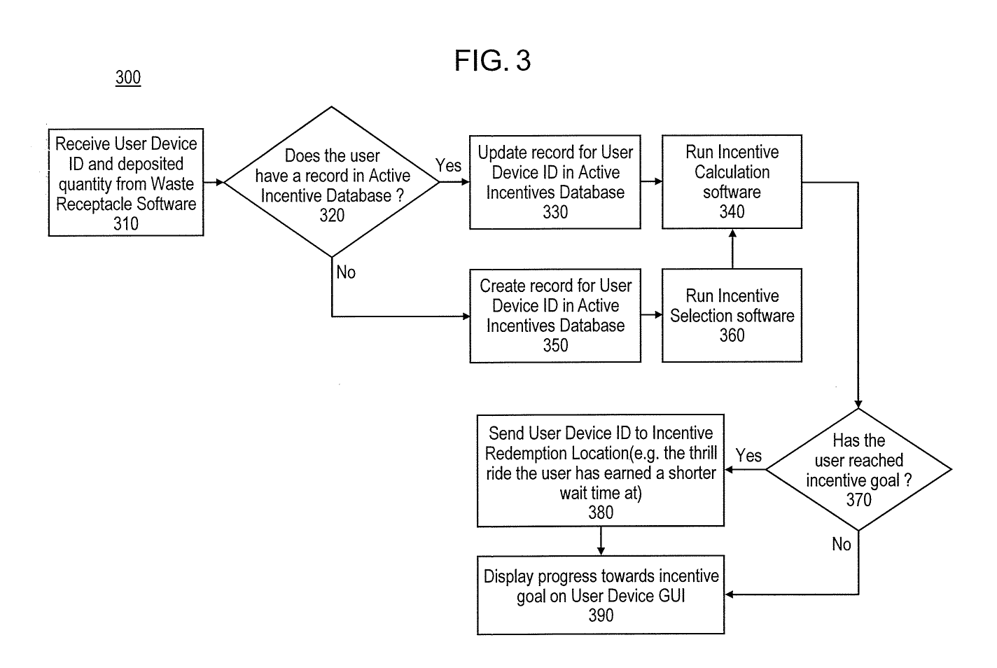

FIG. 3 is a flowchart illustrating an exemplary incentives method 300 that may be used in a system for wearable recycling and cleaning monitoring. Such a method 300 may be performed by execution of recycling incentive base software 130C by a processing system of the resort network server 130.

In step 310, the resort network server 130 may receive a unique user device ID 110B and an associated waste/recycling deposit quantity sent over a communication network from a smart waste receptacle 140. In step 320, the active incentives database 130A may be searched for a record matching the user device ID 110B. If there is a matching record, the method proceeds to step 330 in which the actual deposited quantity as reflected in the active incentives database 130A may be updated by adding the received deposit quantity as measured by the input monitor 140C of the smart connected waste receptacle 140. From there, the method may proceed to step 340 in which incentive calculation software 130E may be executed.

If there is no record in the active incentives database 130A that matches the received user device ID 110B (step 320), the method may proceed to step 350 in which a new record may be created in active incentives database 130A, and the user device ID 110B and the associated deposit quantity may then populate the new record to be stored in the active incentives database 130A. From there, the method may proceed to step 360 in which the incentive selection software 130D may be executed. Execution of the incentive selection software 130D may involve retrieving data from the available incentive database 130B and populating the user device GUI 110A (e.g., with two drop-down menus). The first menu may list attractions information pulled from the available incentives database 130B (e.g., from an incentive redemption locations column). The second menu may be populated after the user has selected an attraction and may display the available incentives for the selected attraction. Once the user makes a selection, the selected incentive may be written to the user's record in the active incentives database 130A. After execution of the incentives selection software 130D in step 360, the method may proceed to step 340.

As noted above with respect to step 340, the incentive calculation software 130E may be executed. Such execution may involve proceeding to step 370 in which the actual deposited amount (as recorded in the active incentives database 130A) is compared to a predetermined incentive threshold goal for deposited amounts. If the actual deposited amount exceeds the incentive threshold, the method proceeds to step 380 in which the user device ID 110B associated with the user device 110 is sent to the incentive redemption location device 120 associated with the selected and achieved incentive and then to step 390 in which the user is notified via the user device GUI 110A regarding the achievement of the goal. If the actual deposited amount does not exceed the incentive threshold, the method proceeds directly to step 390, in which the user device 110 is sent and displays via the GUI 110A the extent of progress made toward the goal (e.g., the percentage of the incentive threshold that is currently met).

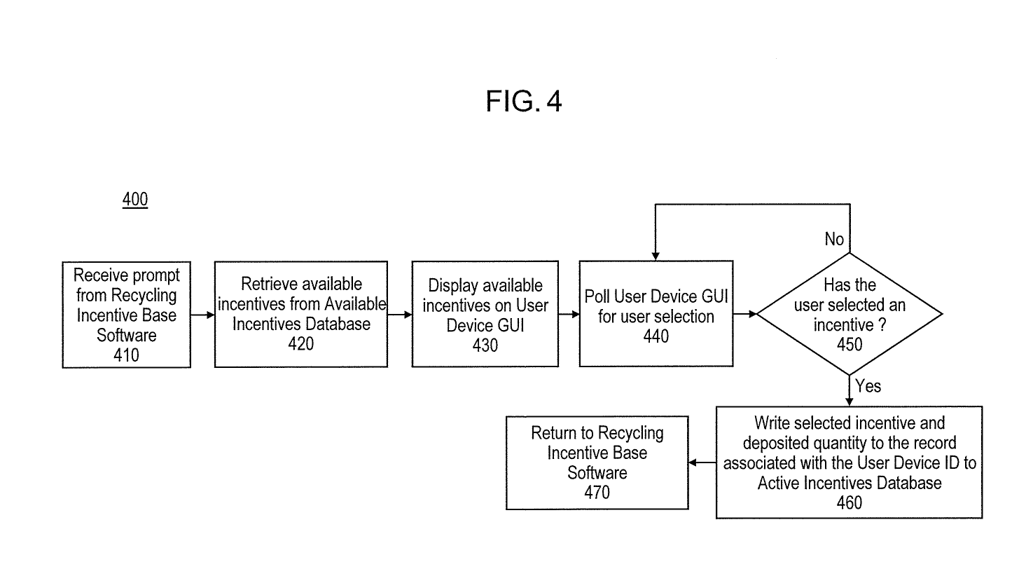

FIG. 4 is a flowchart illustrating an exemplary incentive selection method 400 that may be used in a system of wearable recycling and cleaning monitors. Such a method 400 may be performed by execution of incentive selection software 130D (e.g., in step 360) by a processing system of the resort network server 130.

In step 410, a prompt is received from recycling incentive base software 130C (e.g., when it is determined that there is currently no record in the active incentives database 130A that matches the user device ID 110B). In step 420, information regarding available incentives are retrieved from available incentives database 130B. In step 430, the available incentives are displayed on user device GUI 110A.

In step 440, the user device GUI 110A is polled for a user selection as to the displayed options. In step 450, it is determined whether the user has made a selection. If not, the method returns to step 440 for more polling for user selections. If the user has made a selection, the method proceeds to step 460 in which a new record is created in the active incentives database 130A based on the selected incentive, and the deposited quantity associated with the user device ID 110B is stored in the new record at the active incentives database 130A. The method may then proceed to step 470, in which further instructions of recycling base software 130C may be executed.

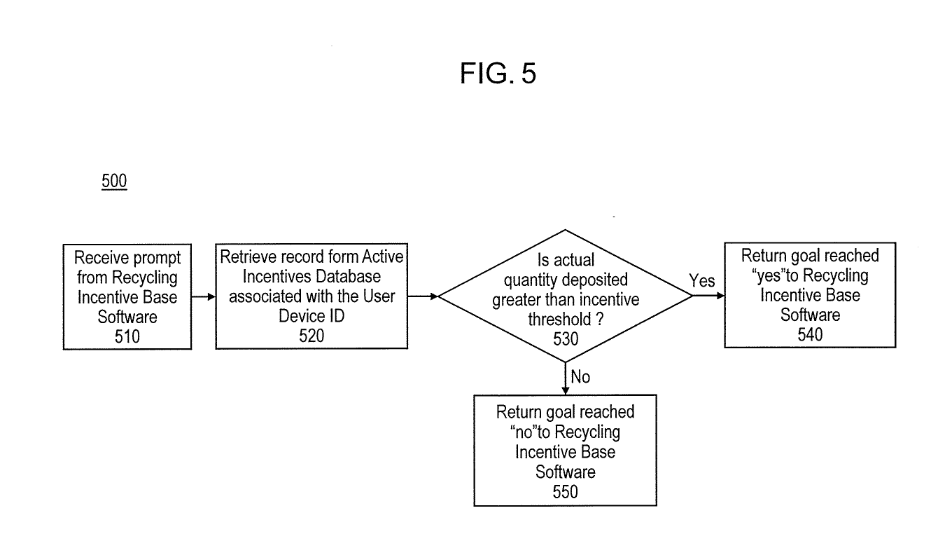

FIG. 5 is a flowchart illustrating an exemplary incentive calculation method 500 that may be used in a system of wearable recycling and cleaning monitors. Such a method 500 may be performed by execution of incentive calculation software 130E by a processing system of the resort network server 130.

In step 510, a prompt is received from recycling incentive base software 130C (e.g., after receiving a new deposited amount associated with a user device ID 110B for which a record exists in active incentives database 130A, such in step 340). In step 520, the record associated with the user device ID 110B is retrieved from active incentives database 130A and updated based on the new deposited amount. In step 530, it may be determined whether the current/updated deposited amount meets a predetermined threshold (e.g., exceeds the threshold, or is equal to or greater than the threshold). If so, the method may proceed to step 540 in which the recycling incentive base software 130C is executed based on the determination that the goal has indeed been reached (e.g., step 370—Yes). If not, the method may proceed to step 550, in which the recycling incentive base software 130C is executed based on the determination that the goal has not been reached (e.g., step 370—No).

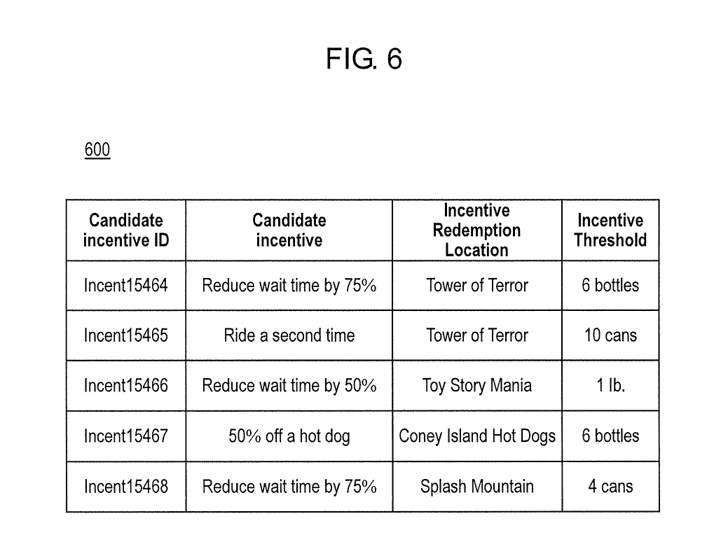

FIG. 6 illustrates an exemplary set of entries 600 from an available incentives database 130B that may be used in a system of wearable recycling and cleaning monitors. As illustrated, such entries 600 may each include a candidate incentive ID (e.g., a unique identifier), a candidate incentive description, an associated incentive redemption location (e.g., associated with one or more incentive redemption location device(s) 120), and an incentive threshold.

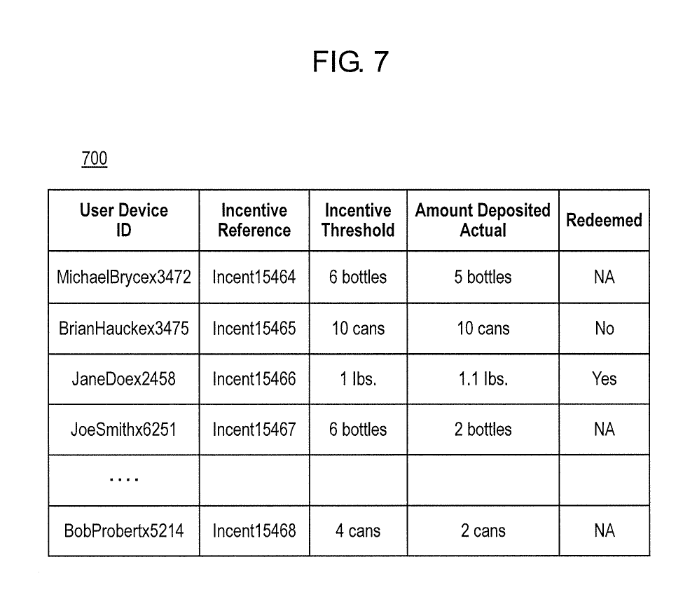

FIG. 7 illustrates an exemplary set of entries 700 from an active incentives database 130A that may be used in a system of wearable recycling and cleaning monitors. As illustrated, each entry 700 may include a user device ID, an incentive reference ID (e.g., an incentive reference ID identifying a candidate incentive ID selected from the available incentives database 130B), an incentive threshold for the deposited amount, a current/actual deposited amount, and an indicator of whether the incentive has been redeemed.

Entries 700 may include all the users in the system in the first column; the incentive each user is working towards in the second column (e.g., as determined by the incentive selection software 130D), the threshold for receiving the selected incentive (e.g., as recorded in the available incentive database 130B after being entered into the system by a manager or administrator) in the third column, the actual amount deposited (e.g., as measured by the smart waste receptacles 140) in the fourth column, and the redemption information in the fifth column. For example, user JaneDoex2458 has reached (and exceeded) the incentive threshold of 1 lbs. of material recycled and has redeemed the associated incentive, whereas BrianHauckex3475 has reached the incentive threshold of 10 cans but has not yet redeemed the earned incentive. The other three guests represented in this table have not reached their respective incentive threshold.

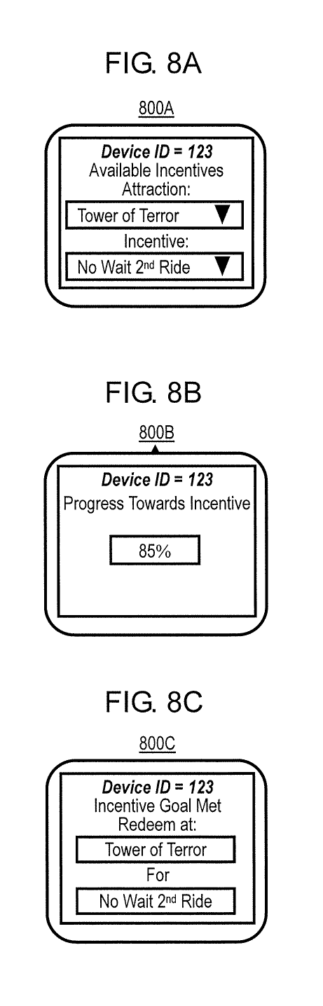

FIGS. 8A-C illustrates exemplary graphic user interfaces (GUIs) that may be used in a system of wearable recycling and cleaning monitors. FIG. 8A is a screenshot that may result from execution of the incentive selection software 130D. Such a screenshot may include a display of a drop-down menu for attractions and a drop down menu for available incentives that are associated with that attraction. Such information comes from the available incentives database 130B.

FIG. 8B is a screenshot that may result from execution of incentive calculation software 130E when the user has not yet met the incentive threshold. As illustrated, a percentage of progress toward the goal may be displayed.

FIG. 8C is a screenshot that may result from execution of incentive calculation software 130E when the user has met the incentive threshold. As illustrated, the display includes a notification that the goal has been met and that the reward may be redeemable at the specified incentive redemption location.

FIG. 9 illustrates an exemplary computing system (e.g., user device, resort network server, smart connected waste receptacle, incentive redemption location device) 900 that may be used to implement an illustrative embodiment. The computing system 900 of FIG. 9 a processing system that includes one or more processor(s) 910 (e.g., microprocessors) and memory 920. Main memory 920 stores, in part, instructions and data for execution by processor 910. Main memory 920 can store the executable code when in operation. The system 900 of FIG. 9 further includes a mass storage device 930, portable storage medium drive(s) 940, output devices 950, user input devices 960, a graphics display 970, and peripheral devices 980.

The components shown in FIG. 9 are depicted as being connected via a single bus 990. However, the components may be connected through one or more data transport means. For example, processor unit 910 and main memory 920 of the processing system may be connected via a local microprocessor bus, and the mass storage device 930, peripheral device(s) 980, portable storage device 940, and display system 970 may be connected via one or more input/output (I/O) buses.

Mass storage device 930, which may be implemented with a magnetic disk drive or an optical disk drive, is a non-volatile storage device for storing data and instructions for use by processor unit 910. Mass storage device 930 can store the system software for implementing embodiments for purposes of loading that software into main memory 920.

Portable storage device 940 operates in conjunction with a portable nonvolatile storage medium, such as a floppy disk, compact disk or Digital video disc, to input and output data and code to and from the computer system 900 of FIG. 9. The system software for implementing various embodiments may be stored on such a portable medium and input to the computer system 900 via the portable storage device 940.

Input devices 960 provide a portion of a user interface. Input devices 960 may include an alpha-numeric keypad, such as a keyboard, for inputting alpha-numeric and other information, or a pointing device, such as a mouse, a trackball, stylus, or cursor direction keys, or a touch-sensitive display. Additionally, the system 900 as shown in FIG. 9 includes output devices 950. Examples of suitable output devices include speakers, printers, network interfaces, and monitors.

Display system 970 may include a liquid crystal display (LCD) or other suitable display device. Display system 970 receives textual and graphical information, and processes the information for output to the display device.

Peripherals 980 may include any type of computer support device to add additional functionality to the computer system. For example, peripheral device(s) 980 may include a modem, a router, or other communication interface device as may be used for communication with a remote computer, server, or other device over a wired or wireless communication link.

The components contained in the computer system 900 of FIG. 9 are those typically found in computer systems that may be suitable for use with embodiments of the disclosure and are intended to represent a broad category of such computer components that are well known in the art. Thus, the computer system 900 of FIG. 9 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A system for waste disposal monitoring using wearable recycling and cleaning monitors, the system comprising:
a plurality of user devices each associated with a unique identifier and each configured to be carried by a respective user; and
a smart waste receptacle comprising:
a receptacle configured to hold a plurality of waste items;
a reader configured to detect the unique identifier of one user device of the plurality of user devices when the user carrying the one user device deposits a waste item in the receptacle; and
a communication interface configured to transmit a notification including the detected unique identifier of the one user device based on the user carrying the one user device depositing the waste item in the receptacle.

2. The system according to claim 1,
wherein the smart waste receptacle further includes an input monitor configured to detect that the user has deposited the waste item in the receptacle, and
the communication interface is configured to transmit the notification including the detected unique identifier of the one user device only when the reader detects the unique identifier of the one user device and the input monitor detects that the user has deposited the waste item in the receptacle.

3. The system according to claim 2, further comprising:
a processing system configured to receive the notification from the communication interface of the smart waste receptacle and to maintain a database including records each associated with a unique identifier of a user device of the plurality of user devices,
wherein the processing system increments the record associated with the unique identifier of the one user device each time a notification including the detected unique identifier for the one user device is received.

4. The system according to claim 3,
wherein the input monitor of the smart waste receptacle further detects a quantity of the waste item deposited by the user in the receptacle,
the communication interface transmits the notification including the detected unique identifier of the user device and the detected quantity of the waste item deposited by the user in the receptacle, and
the processing system increments the record associated with the unique identifier of the one user device according to the detected quantity of the waste item included in the notification.

5. The system according to claim 4, wherein the input monitor includes a scale or an optical sensor.

6. The system according to claim 3, further comprising:
a network server comprising the processing system, wherein the network server is communicatively connected to the smart waste receptacle through a wired or wireless communication link.

7. The system according to claim 3, further comprising:
an incentive redemption location device communicatively connected to the processing system and configured to issue, to one user having a user device of the plurality of user devices, an incentive based on a determination made by the processing system,
wherein the processing system maintains the database to include, for each record associated with a unique identifier of a user device, a threshold value associated with issue of the incentive, and the processing system causes the incentive redemption location device to issue the incentive to the one user when the record associated with the unique identifier of one user's user device meets the threshold value associated with the record.

8. The system according to claim 3,
wherein each user device comprises:
a user interface operative to provide information to the respective user, and
a wireless communication interface configured for communication with the processing system; and
the processing system is configured to transmit to each respective user device information on the incremented record associated with the unique identifier of the respective user device.

9. The system according to claim 8,
wherein the user interface of each user device is further operative to receive a selection of an incentive from the respective user,
each user device is configured to transmit the received selection of an incentive to the processing system through the wireless communication interface, and
the processing system maintains the database to include, for each record associated with a unique identifier of a user device, a threshold value associated with the incentive selected by the respective user of the user device.

10. The system according to claim 9, further comprising:
an incentive redemption location device communicatively connected to the processing system and configured to issue, to one user having a user device of the plurality of user devices, an incentive based on a determination made by the processing system,
wherein the processing system causes the incentive redemption location device to issue the incentive selected by a particular user when the record associated with the unique identifier of the particular user's user device meets the threshold value associated with the record.

11. A method for waste disposal monitoring using wearable recycling and cleaning monitors, the method comprising:
detecting, by a reader of a smart waste receptacle configured to hold a plurality of waste items, a unique identifier of a user device configured to be carried by a respective user;
detecting, by an input monitor of the smart waste receptacle, that the user carrying the user device has deposited a waste item in the smart waste receptacle; and
transmitting, from the smart waste receptacle, a notification including the detected unique identifier of the user device when the input monitor detects that the user has deposited the waste item in the smart waste receptacle.

12. The method according to claim 11, further comprising:
maintaining a database storing records each associated with a unique identifier of a user device among a plurality of user devices; and
incrementing the record associated with a particular unique identifier in the database each time a notification including the particular unique identifier is transmitted by the smart waste receptacle.

13. The method according to claim 12, wherein the detecting by the input monitor comprises detecting a quantity of the waste item that the user carrying the user device has deposited in the smart waste receptacle, and
the incrementing the record associated with a particular unique identifier comprises incrementing the record in the database according to the detected quantity of the waste item detected by the input monitor.

14. The method according to claim 12, further comprising:
determining whether the incremented record associated with the particular unique identifier in the database meets a threshold; and
in response to determining that the incremented record meets the threshold, causing an incentive redemption location device communicatively connected to the processing system to issue an incentive to a user having the user device with the particular unique identifier.
